(19) United States
(12) Patent Application Publication
(10) Pub. No.: US 2024/0294092 A1
(43) Pub. Date: Sep. 5, 2024

(54) OPEN/CLOSE CONTROL APPARATUS AND VEHICLE

(71) Applicant: ISUZU MOTORS LIMITED, Yokohama-shi (JP)

(72) Inventors: Shouhei NAKAYAMA, Fujisawa-shi (JP); Takuya KIKUCHI, Fujisawa-shi (JP); Ryuichi TAKAO, Fujisawa-shi (JP); Shouta ICHIKAWA, Fujisawa-shi (JP)

(21) Appl. No.: 18/583,716

(22) Filed: Feb. 21, 2024

(30) Foreign Application Priority Data
Mar. 3, 2023 (JP) 2023-032729

(51) Int. Cl. B60L 58/12; B60L 3/00

(52) U.S. Cl. CPC B60L 58/12; B60L 3/0046; B60L 2240/549

(57) ABSTRACT

An open/close control apparatus includes obtaining sections that obtain values of currents and a control section that controls opening and closing of open/close sections. When values of currents flowing to a plurality of batteries are larger than an allowable value after a power supply stop instruction for a load is issued, the control section keeps the open/close sections closed, and when the values of the currents flowing to the plurality of batteries are smaller than or equal to the allowable value, the control section opens the open/close sections.

### TECHNICAL FIELD

The present disclosure relates to an open/close control apparatus and a vehicle.

### BACKGROUND ART

It is known that a plurality of batteries connected in parallel with one another are provided for a vehicle capable of operating on electric power. The plurality of batteries supplies power to a load when relays (open/close sections) provided for power supply paths of the batteries close.

When potential differences are caused between the plurality of batteries, return currents are caused between the plurality of batteries, which can lead to malfunction of the batteries. In order to reduce an effect of such return currents, PTL 1, for example, discloses a configuration where return currents are mitigated by causing a current to flow to each battery through an inrush current prevention resistor after supply of power is stopped.

### CITATION LIST

### Patent Literature

### PTL 1

Japanese Patent Application Laid-Open No. 2013-240142

### SUMMARY OF INVENTION

### Technical Problem

When open/close sections are opened and closed while return currents are caused, however, the open/close sections can deteriorate fast.

The present disclosure aims to provide an open/close control apparatus and a vehicle capable of inhibiting open/close sections from deteriorating due to return currents.

### Solution to Problem

An open/close control apparatus according to the present disclosure is an apparatus for a vehicle including a plurality of batteries connected in parallel with one another and open/close sections that open and close power supply paths from the plurality of batteries to a load, the open/close control apparatus including: an obtaining section that obtains values of currents flowing to the plurality of batteries; and a control section that controls opening and closing of the open/close sections, in which, when the values of the currents flowing to the plurality of batteries are larger than an allowable value after a power supply stop instruction for the load is issued, the control section keeps the open/close sections closed, and when the values of the currents flowing to the plurality of batteries are smaller than or equal to the allowable value, the control section opens the open/close sections.

A vehicle according to the present disclosure includes: a plurality of batteries connected in parallel with one another; open/close sections that open and close power supply paths from the plurality of batteries to a load; an obtaining section that obtains values of currents flowing to the plurality of batteries; and a control section that controls opening and closing of the open/close sections, in which, when the values of the currents flowing to the plurality of batteries are larger than an allowable value after a power supply stop instruction for the load is issued, the control section keeps the open/close sections closed, and when the values of the currents flowing to the plurality of batteries are smaller than or equal to the allowable value, the control section opens the open/close sections.

### Advantageous Effects of Invention

According to the present disclosure, open/close sections can be inhibited from deteriorating due to return currents.

### BRIEF DESCRIPTION OF DRAWINGS

FIG. 1 is a diagram illustrating a vehicle provided with an open/close control apparatus according to an embodiment of the present invention;

FIG. 2 is a flowchart illustrating an example of operation for open/close control performed by the open/close control apparatus; and

FIG. 3 is a flowchart illustrating an example of operation for open/close control performed by an open/close control apparatus according to a modification.

### DESCRIPTION OF EMBODIMENTS

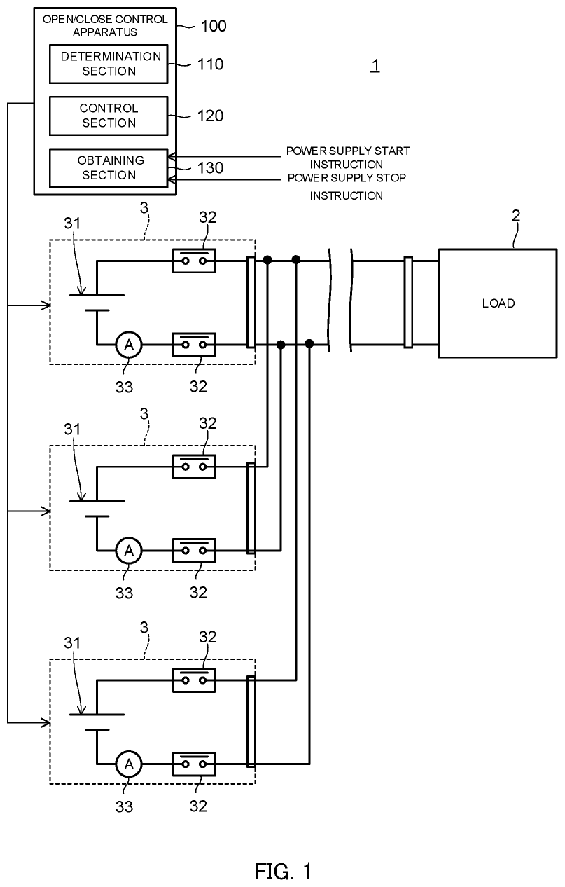

An embodiment of the present disclosure will be described in detail hereinafter on the basis of the drawings. FIG. 1 is a diagram illustrating a vehicle provided with an open/close control apparatus according to the embodiment of the present disclosure.

Vehicle 1 is a vehicle capable of running using batteries 31, such as an electric car or a hybrid vehicle. Vehicle 1 includes, for example, load 2 capable of operating on electric power, such as a motor, battery apparatuses 3, and open/close control apparatus 100. Vehicle 1 performs, using open/close control apparatus 100, control for inhibiting open/close sections 32 from deteriorating due to return currents caused between battery apparatuses 3 (batteries 31).

Battery apparatuses 3 are connected to load 2 in parallel with one another and capable of supplying power to load 2. Each battery apparatus 3 has the same configuration and includes battery 31, open/close sections 32, and current detection section 33.

Battery 31 is capable of supplying power to load 2 because positive and negative terminals thereof are connected to power supply paths connected to load 2.

Open/close sections 32 are relay circuits that open and close the power supply paths of battery 31. One open/close section 32 is provided for each of positive and negative power supply paths of battery 31. It is known that life (upper limit) of a relay circuit differs depending on contact current. When a large current flows every time a relay circuit opens and closes, an upper limit to the number of operations might decrease. In other words, when a large current flows every time a relay circuit opens and closes, the relay circuit undesirably deteriorates fast due to the opening and closing. For example, durability properties are defined for a relay circuit in accordance with a current used.

When open/close sections 32 close, battery 31 can supply power to load 2 through the power supply paths. When open/close sections 32 open, the power supply paths are disconnected, and battery 31 does not supply power to load 2.

Current detection section 33 is a known current sensor, for example, and detects a value of a current flowing to battery 31. Current detection section 33 is provided, for example, in the power supply path connected to the negative terminal of battery 31.

Open/close control apparatus 100 includes a central processing unit (CPU), a read-only memory (ROM), a random-access memory (RAM), and an input/output circuit, which are not illustrated. The CPU achieves functions of determination section 110 and control section 120 of open/close control apparatus 100, which will be described later, by executing a program read from the ROM. Open/close control apparatus 100 is capable of obtaining a key ON operation instruction (power supply start instruction) and a key OFF operation instruction (power supply stop instruction) issued by a driver of vehicle 1, for example, and controls an open/close state of open/close sections 32 of each battery apparatus 3 on the basis of these instructions.

More specifically, when obtaining a power supply start instruction, open/close control apparatus 100 closes open/close sections 32, and when obtaining a power supply stop instruction, open/close control apparatus 100 opens open/close sections 32. Open/close control apparatus 100 includes determination section 110, control section 120, and obtaining section 130.

Batteries 31 might have potential differences due to, for example, differences in internal resistance, differences in deterioration, and the like. When potential differences are caused between batteries 31, currents flow from high-potential batteries 31 to low-potential batteries 31. That is, return currents are caused due to the potential differences.

As potentials of high-potential batteries 31 and low-potential batteries 31 become close to each other, values of return currents decrease. As described above, since a relay circuits deteriorates fast due to opening and closing when a large current flows every time the relay circuit opens and closes, open/close sections 32 can deteriorate fast when open/close sections 32 open and close while return currents are caused. It is therefore desirably to open a relay circuit while a return current flowing to the relay circuit is sufficiently small.

Each current detection section 33 can detect a value of a return current, and it is therefore desirable not to open and close open/close sections 32 while an excessive return current is being detected and not to open open/close sections 32 until the return current decreases to some degree.

In the present embodiment, therefore, when return currents between batteries 31 are larger than an allowable value after a power supply stop instruction for load 2 is issued, determination section 110 keeps open/close sections 32 closed, and when the return currents are smaller than or equal to the allowable value, determination section 110 opens open/close sections 32.

More specifically, when a power supply stop instruction is obtained while open/close sections 32 are closed, that is, while batteries 31 are supplying power to load 2, determination section 110 obtains values of current of batteries 31 from corresponding current detection sections 33. Determination section 110 determines a time at which the values of current of batteries 31 become smaller than or equal to the allowable value of open/close sections 32 as an opening time.

It is assumed that the allowable value is set to a value of current with which an upper limit to the number of operations of open/close sections 32 becomes larger than or equal to the number of operations expected for vehicle 1. It is assumed, for example, that, with durability properties set in advance for open/close sections 32, the number of operations of 300×10⁴ is specified as an expected life span with a current of 1 [A] and the number of operations of 90×10⁴ is specified as an expected life span with a current of 2 [A]. When life of open/close sections 32 needs to be 100×10⁴ or more for vehicle 1, the allowable value can be set to 1 [A].

Control section 120 opens and closes open/close sections 32 on the basis of a determination made by determination section 110. More specifically, control section 120 opens open/close sections 32 at an opening time determined by determination section 110.

Obtaining section 130 obtains a value of a current flowing to each battery 31 from current detection section 33 of battery 31. Obtaining section 130 can also obtain a power supply start instruction and a power supply stop instruction output in accordance with operations performed on an ignition switch, which is not illustrated. Information obtained by obtaining section 130 is output to determination section 110 and control section 120.

As a result, open/close sections 32 are not opened or closed while return currents are caused.

In addition, when a power supply start instruction for load 2 is issued, control section 120 closes open/close sections 32.

Control section 120 can thus open and close open/close sections 32 at appropriate times.

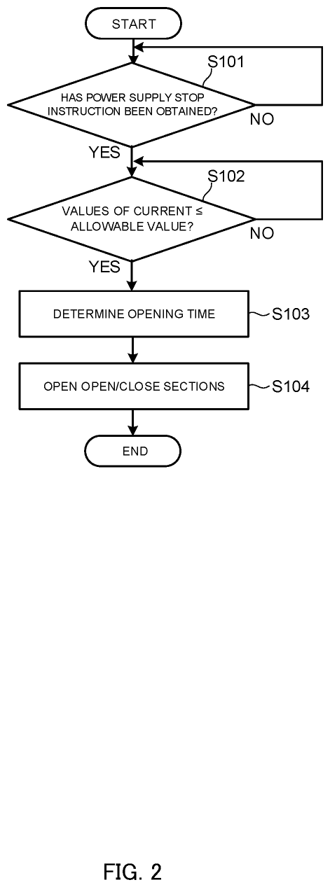

An example of operation for open/close control performed by open/close control apparatus 100 configured as described above will be described. FIG. 2 is a flowchart illustrating an example of the operation for the open/close control performed by open/close control apparatus 100. A process illustrated in FIG. 2 is performed as appropriate when, for example, a power supply start instruction is issued and open/close sections 32 are closed.

As illustrated in FIG. 2, open/close control apparatus 100 determines whether a power supply stop instruction has been obtained (step S101). When open/close control apparatus 100 determines that a power supply stop instruction has not been obtained (NO in step S101), the processing in step S101 is repeated.

When a power supply stop instruction has been obtained (YES in step S101), on the other hand, open/close control apparatus 100 determines whether the values of current of batteries 31 have become smaller than or equal to the allowable value (step S102).

When open/close control apparatus 100 determines that the values of current are larger than the allowable value (NO in step S102), the processing in step S102 is repeated. When the values of current are smaller than or equal to the allowable value (YES in step S102), on the other hand, open/close control apparatus 100 determines an opening time (step S103) and opens open/close sections 32 (step S104).

The control ends after step S104.

According to the present embodiment configured as described above, when a power supply stop instruction for load 2 is issued, an opening time of open/close sections 32 is determined on the basis of return currents between batteries 31. More specifically, a time after the values of current of batteries 31 become smaller than or equal to the allowable value of open/close sections 32 is determined as an opening time. The opening time may be a point in time when a certain period of time has elapsed since the values of current became smaller than or equal to the allowable value.

As a result, since open/close sections 32 are not opened or closed while return currents larger than the allowable value are caused, open/close sections 32 can be inhibited from deteriorating due to return currents.

Although open/close sections 32 are not opened until the values of current become smaller than or equal to the allowable value in the above embodiment, the present disclosure is not limited to this. When a certain period of time has elapsed since a power supply stop instruction was issued, for example, control section 120 may open open/close sections 32. The certain period of time is, for example, a period of time (e.g., 10 minutes) that can be set as appropriate and may be, for example, a period of time for which batteries 31 may continuously supply power to load 2.

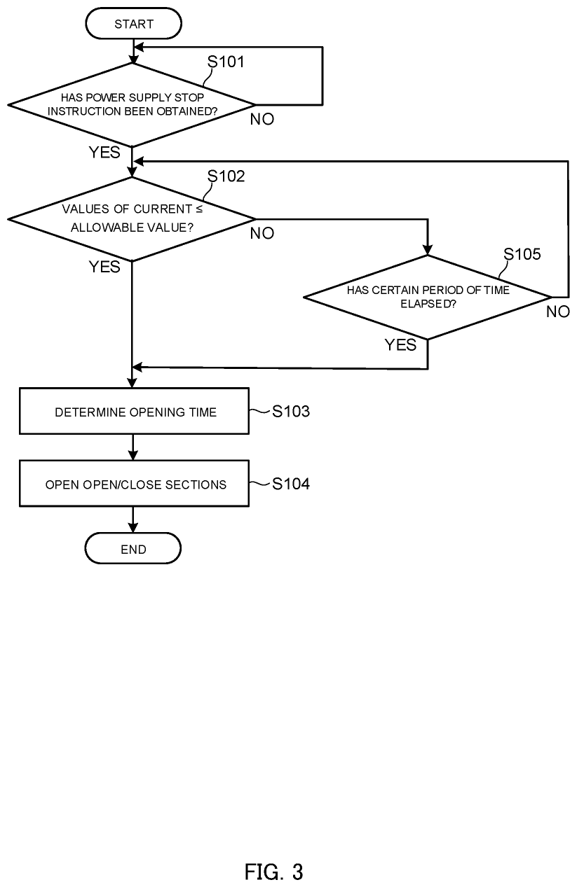

FIG. 3 is a flowchart illustrating an example of operation for open/close control performed by open/close control apparatus 100 according to a modification. A process illustrated in FIG. 3 is different from that illustrated in FIG. 2 in that processing in step S105 is performed when the result of step S102 in FIG. 2 is NO.

As illustrated in FIG. 3, when open/close control apparatus 100 determines in step S102 that the values of current are larger than the allowable value (NO in step S102), open/close control apparatus 100 determines whether a certain period of time has elapsed (step S105).

When open/close control apparatus 100 determines that the certain period of time has not elapsed (NO in step S105), the process returns to step S102. When the certain period of time has elapsed (YES in step S105), on the other hand, the process proceeds to step S103. Processing in and after step S103 is the same as in FIG. 2.

With this configuration, power can be inhibited from being continuously supplied to load 2.

In addition, although open/close sections 32 are closed when a power supply start instruction is issued after open/close sections 32 are opened in the above embodiment, the present disclosure is not limited to this. For example, when a power supply start instruction for load 2 is issued after open/close sections 32 are opened and there are potential differences between batteries 31, control section 120 may control open/close sections 32 such that supply of power to at least one of batteries 31 is restricted.

The open/close control apparatus 100 may make the determination as to potential differences between batteries 31 by, for example, obtaining a result of detection performed by a voltage detection section (not illustrated) provided for each battery apparatus 3.

It is assumed, for example, that the potentials of batteries 31 were the same when open/close sections 32 were opened but there are potential differences between batteries 31 due to electrical discharge or the like when open/close sections 32 are closed.

In this case, when the potential differences between batteries 31 are relatively large, inrush currents might be caused when open/close sections 32 are closed in accordance with a power supply start instruction, and open/close sections 32 and the like might malfunction.

When two of three batteries 31 illustrated in FIG. 1 have a first potential (e.g., 360 V) and the other battery 31 has a second potential (e.g., 340 V), for example, control section 120 performs control in such a way as to close open/close sections 32 of battery apparatuses 3 corresponding to the first potential without closing open/close section 32 of battery apparatus 3 corresponding to the second potential.

As a result, occurrence of inrush currents when open/close sections 32 are closed can be inhibited while inhibiting return currents between batteries 31.

In addition, although a time at which the values of current of batteries 31 become smaller than or equal to the allowable value is an opening time of open/close sections 32 in the above embodiment, the present disclosure is not limited to this. A time after the values of current become smaller than or equal to the allowable value may be an opening time, instead. A period of time from the values of current becoming smaller than or equal to the allowable value to the opening time may be set as appropriate.

In addition, although open/close control apparatus 100 is provided for vehicle 1 in the above embodiment, the present disclosure is not limited to this. Open/close control apparatus 100 may be provided for another apparatus (e.g., a mobile terminal, a server, etc.), instead.

Furthermore, the above embodiment is just a specific example where the present disclosure is implemented, and should not be construed as limiting the technical scope of the present disclosure. That is, the present disclosure can be implemented in various manners without deviating from the spirit or principal features thereof.

This application is entitled and claims the benefit of Japanese Patent Application No. 2023-032729, filed on Mar. 3, 2023, the disclosure of which including the specification, drawings and abstract is incorporated herein by reference in its entirety.

### INDUSTRIAL APPLICABILITY

The open/close apparatus in the present disclosure is effective as an open/close control apparatus and a vehicle capable of inhibiting open/close sections from deteriorating due to return currents.

1. An open/close control apparatus for a vehicle including a plurality of batteries connected in parallel with one another and open/close sections that open and close power supply paths from the plurality of batteries to a load, the open/close control apparatus comprising:
an obtaining section that obtains values of currents flowing to the plurality of batteries; and
a control section that controls opening and closing of the open/close sections,
wherein, when the values of the currents flowing to the plurality of batteries are larger than an allowable value after a power supply stop instruction for the load is issued, the control section keeps the open/close sections closed, and when the values of the currents flowing to the plurality of batteries are smaller than or equal to the allowable value, the control section opens the open/close sections.

2. The open/close control apparatus according to claim 1, further comprising: a determination section that determines, based on the values of the currents flowing to the plurality of batteries, an opening time at which the control section is to open the open/close sections,
wherein the determination section determines, as the opening time, a time after each of the values of the currents flowing to the plurality of batteries becomes smaller than or equal to the allowable value of the open/close sections.

3. The open/close control apparatus according to claim 1,
wherein, when a power supply start instruction for the load is issued, the control section closes the open/close sections.

4. The open/close control apparatus according to claim 1,
wherein, when a certain period of time has elapsed since issuance of the power supply stop instruction, the control section opens the open/close sections even when the values of the currents are larger than or equal to the allowable value.

5. The open/close control apparatus according to claim 1,
wherein, when a power supply start instruction for the load is issued after the open/close sections are opened and there is a potential difference between the plurality of batteries, the control section controls the open/close sections in such a way as to restrict supply of power to at least one of the plurality of batteries.

6. A vehicle comprising:
a plurality of batteries connected in parallel with one another;
open/close sections that open and close power supply paths from the plurality of batteries to a load;
an obtaining section that obtains values of currents flowing to the plurality of batteries; and
a control section that controls opening and closing of the open/close sections,
wherein, when the values of the currents flowing to the plurality of batteries are larger than an allowable value after a power supply stop instruction for the load is issued, the control section keeps the open/close sections closed, and when the values of the currents flowing to the plurality of batteries are smaller than or equal to the allowable value, the control section opens the open/close sections.
